(19) United States
(12) Patent Application Publication
(10) Pub. No.: US 2020/0363925 A1
(43) Pub. Date: Nov. 19, 2020

(54) Adaptive Touch User Interface Systems and Methods

(71) Applicant: Bayerische Motoren Werke Aktiengesellschaft, Muenchen (DE)

(72) Inventors: Franziska LANG, Ventura, CA (US); Martin Francisco, Pasadena, CA (US); Eric Brown, North Hollywood, CA (US); Matthew Potter, Porter Ranch, CA (US); Paul Ferraiolo, Ventura, CA (US); Ross Carmichael, Everrett, WA (US)

(21) Appl. No.: 16/546,160

(22) Filed: Aug. 20, 2019

(51) Int. Cl. G06F 3/0488; G06F 3/041; B60K 37/06

(52) U.S. Cl. CPC G06F 3/0488; G06F 3/0416; B60K 37/06; B60K 2370/1468; B60K 2370/166; B60K 2370/1442; B60K 2370/1438

(57) ABSTRACT

A system for an adaptive touch user interface includes a visual display and an adaptive touch-input interface. The visual display is configured to display one or more interactive elements thereon in accordance with a software application that receives user input in connection with displayed information. The touch-input interface is configured to receive user input and communicate the user input to the software application. The touch-input interface also has a surface profile that is adaptable in connection with the display of the one or more interactive elements.

### FIELD OF THE INVENTION

The present invention relates generally to adaptive touch user interfaces, and more particularly to adaptive touch user interfaces having surface profiles that are adaptable in connection with the display of the one or more interactive elements.

### BACKGROUND OF THE INVENTION

As vehicles and other systems increasingly rely on receiving user input via touchpad user interfaces, the likelihood for user distraction while providing that input also increases. This is because current touchpad technology provides for a single static surface that receives the user input. As such, the user must divert his/her attention to the touchpad in order to accurately provide the desired input.

Moreover, current vehicle system controls that utilize such touchpad in connection with displayed information are limited to displaying to displaying all functionalities at the same time and/or in the same format (e.g., as a grid of selectable apps). This may be overwhelming and may require extra mental effort to navigate through.

The current rotary knob controller is able to scroll through lists, but is unable to effectively navigate an app based layout. And while it has been suggested to adapt the main console of the vehicle to a touch screen, main consoles are traditionally difficult to reach, are ergonomically awkward, and take away from driver attention.

As such, there is a need in the art for devices, systems and methods that do not suffer from the above drawbacks.

### SUMMARY OF THE INVENTION

Disclosed and claimed herein adaptive touch user interface systems and methods that overcomes the shortcomings of the prior art.

A system for an adaptive touch user interface is described herein. The system includes a visual display and an adaptive touch-input interface. The visual display is configured to display one or more interactive elements thereon in accordance with a software application that receives user input in connection with displayed information. The touch-input interface is configured to receive user input and communicate the user input to the software application. The touch-input interface also has a surface profile that is adaptable in connection with the display of the one or more interactive elements.

A vehicle having an adaptive touch user interface is also described herein. The vehicle includes a control unit configured to execute a software application for controlling one or more vehicle systems. The software application receives user input in connection with displayed information. The vehicle also includes a visual display configured to display one or more interactive elements thereon in accordance with the software application. The vehicle also includes a touch-input interface configured to receive user input and communicate the user input to the software application. The touch-input interface includes a surface profile adaptable in connection with the display of the one or more interactive elements.

A method for providing user input to a software application is also described herein. Interactive elements are visually displayed on a visual display in accordance with the software application. A surface profile of a touch-input interface is adapted in connection with the display of the one or more interactive elements. User input is received via the touch-input interface having the adapted surface profile. The received user input is communicated to the software application.

The present disclosure provides for a number of benefits and/or advantages over the prior art. For example, cognitive load may be reduced, as only the appropriate configuration for navigating the current layout of displayed information may be provided, e.g., lists may be navigated with a swipe bar, whereas an app based layout may be navigated with a square trackpad. Vehicle aesthetic may also be improved, as the control surface may, when not in use, adapt to blend into the vehicle interior.

Other objects, advantages, aspects and features of the present invention will be apparent to one skilled in the relevant art in view of the following detailed description of one or more exemplary embodiments.

### BRIEF DESCRIPTION OF THE DRAWINGS

The features, objects, and advantages of the present invention will become more apparent from the detailed description, set forth below, when taken in conjunction with the drawings, in which like reference characters identify correspondingly throughout and wherein:

FIG. 1 illustrates an example system in accordance with one or more aspects of the present invention;

FIG. 2 illustrates exemplary operational states of the example system of FIG. 1 in accordance with one or more aspects of the present invention; and

FIG. 3 illustrates a flow diagram of an algorithm used by the example system of FIG. 1 in accordance one or more aspects of the present invention.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated. It will therefore be understood that what is illustrated is set forth for the purposes of example, and should not be taken as a limitation on the scope of the present invention.

The present invention generally relates to an adaptive touch user interface having a surface profile that is adaptable in connection with the display of the one or more interactive elements.

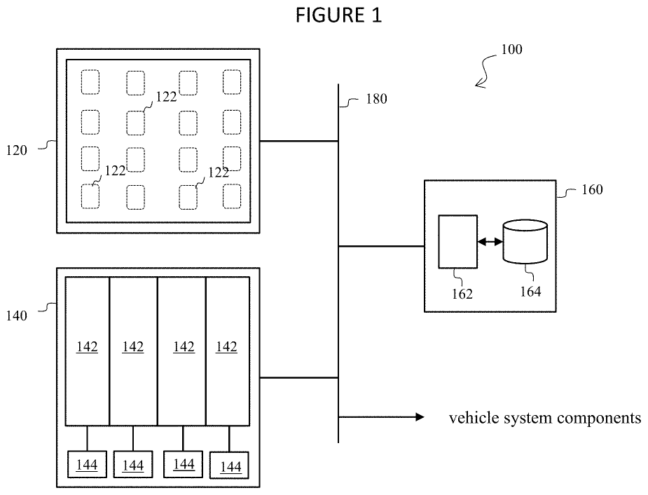

FIG. 1 illustrates an example system 100 for an adaptive touch user interface in accordance with one or more embodiments of the present invention. The system 100 includes a visual display 120 and a touch-input interface 140, each operatively coupled via network 180 to a control unit 160 executing a software application thereon.

The software application may be any software application that involves the receipt of user input in connection with displayed information. Exemplary software applications include software applications for controlling various vehicle systems, such as vehicle entertainment systems, climate control systems, driver assistance systems, security systems, navigation systems, etc., through user input, as well as operating systems and other software applications.

The visual display 120 may be any type of device capable of visually communicating information to a user, such as a liquid-crystal display (“LCD”) screen, a plasma screen, etc. The visual display 120 may be configured to visually display one or more interactive elements 122 thereon in accordance with software applications being executed by the control unit 160. The interactive elements 122 may be arranged according to various arrangements, such as lists, matrices, etc.

The touch-input interface 140 may be any type of interface capable of allowing a user to provide the user input in accordance with the software application via touch, e.g., a touch-sensitive surface. The touch-input interface 140 may include a plurality of touch-input surface elements 142, which define the surface profile, and which individually and collectively may be capable of allowing the user to provide the user input.

The touch-input interface 140 may be configured to allow the user to provide the user input by way of selecting one or more of the interactive elements 122 displayed on the visual display 120, or otherwise interacting with the system 100 in accordance with the software application. Accordingly, portions of the touch-input interface 140 may correspond to portions of the visual display 120 such that touch input received by the touch-input interface 140 may cause the generation of a corresponding visualization on the display 120.

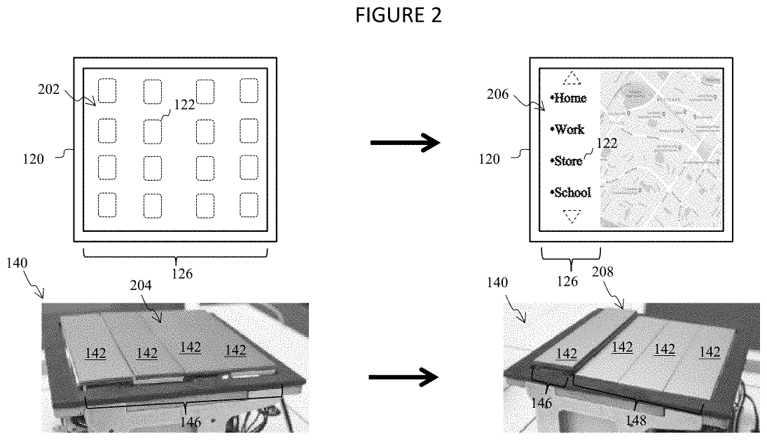

The touch-input interface 140 may further include one or more actuators 144 configured to adapt the surface profile in accordance with the displayed interactive elements 120. Referring now to FIG. 2, the one or more actuators may, for example, extend/retract each touch-input surface element 142 on an individual basis with respect to a neutral position in which the touch-input surface elements 142 together form a substantially planar surface. The actuators 144 may be controlled by the control unit 160 extend/retract each touch-input surface element 142, in accordance with the software application, such that the extension/retraction of each touch-input surface element 142 corresponds to the arrangement of the interactive elements displayed on the visual display 120. In other words, the extended/retracted touch-input surface elements 142 define an active area 146 of the touch-input interface 140, which corresponds to an interactive area 126 of the visual display, where the interactive elements 122 are located. The controller 160 may also selectively deactivate touch-input surface elements 142 that are not part of the active area 146, forming an inactive area 148, such that touching those touch-input surface elements 142 of the inactive area 148 does not provide user input.

Referring back to FIG. 1, the network 180 may be any type of network, wired or wireless, configured to facilitate the communication and transmission of data, instructions, etc. from one component to another component of the system 100. For example, the network 180 may be a local area network (LAN) (e.g., Ethernet or other IEEE 802.03 LAN technologies), Wi-Fi (e.g., IEEE 802.11 standards), wide area network (WAN), virtual private network (VPN), global area network (GAN), any combination thereof, or any other type of network. In at least one embodiment, the network 180 is an on-vehicle network.

The control unit 160 may include a processor 162 and a memory 164. The processor may instruct other components, such as the touch-input interface 140 and the visual display 120, to perform various tasks based on the processing of information and/or data that may have been previously stored or has been received, such as instructions and/or data stored in memory 164. The processor 112 may be a standard processor, such as a central processing unit (CPU), or may be a dedicated processor, such as an application-specific integrated circuit (ASIC) or a field programmable gate array (FPGA).

Memory 164 stores at least instructions and/or data that can be accessed by processor 162. For example, memory 164 may be hardware capable of storing information accessible by the processor, such as a ROM, RAM, hard-drive, CD-ROM, DVD, write-capable, read-only, etc. The set of instructions may be included in software that can be implemented by the system 100. It should be noted that the terms “instructions,” “steps,” “algorithms,” and “programs” may be used interchangeably. Data can be retrieved, manipulated or stored by the processor 162 in accordance with the set of instructions or other sets of executable instructions. The data may also be stored as a collection of data.

It is to be understood that the configuration illustrated in FIG. 1 serves only as an example and is thus not limited thereto. The system 100, for instance, may include numerous other components connected to network 180, and may include more than one of each network component. Network 180 may also be connected to other networks.

In at least one embodiment, a vehicle (not shown) may be provided with the system 100 for an adaptive touch user interface. In such embodiments, the vehicle may include a panel surface, which may at least partially comprise the touch-input interface 140 such that the touch-input interface 140 is, when in the neutral position, substantially flush with the remainder of the panel surface adjacent thereto. The panel surface may include, for example, a dashboard surface, a console surface, a door surface, a ceiling surface, a floor surface, an armrest surface, or any other vehicle surface accessible by the user.

An exemplary operation of the system 100 will now be described with reference to FIGS. 1-2. Software application(s) for managing vehicle systems may involve displaying the one or more interactive elements 122 on the visual display 120. For example, the visual display 120 may display interactive elements 122 corresponding to various vehicle systems to be controlled (e.g., audio, navigation, climate, etc.) which display may be in accordance with grid arrangement 202, such as that shown in FIG. 2.

In accordance with the grid arrangement 202 of the displayed interactive elements 122, the control unit 160 may control the actuators 142 to extend the touch-input surface elements 142 so as to form the touch-input interface 140 in a substantially planar surface profile 204. In the substantially planar surface profile 204, substantially the entire surface of the touch-input interface 140 defines the active area 146, which corresponds to the interactive area 126 of the visual display 120 being substantially the entire display. This arrangement allows the user to interact with any of the interactive elements 122 displayed in a natural and intuitive manner.

For example, referring to FIG. 2, the user may touch the portion of the touch-input interface 140 corresponding to a “navigation” icon on the visual display 120, which may provide user input resulting in the “navigation” icon 122a being selected and a list arrangement 206 of interactive elements 122 being displayed on the visual display 120.

In accordance with the list arrangement 206 of the displayed interactive elements 122, the control unit 160 may control the actuators 142 to extend the touch-input surface elements 142 so as to form the touch-input interface 140 in a left bar surface profile 208, while inactive touch-elements 142 may also be retracted. In the left bar surface profile 208, the active area 146 is defined by a bar of one or more touch-input surface elements 142 on the left side of the touch-input interface 140, which corresponds to the interactive area 126 of the visual display 120 being the list of interactive elements 122. This arrangement allows the user to interact with the displayed list of interactive elements 122 in a natural and intuitive manner.

For example, referring back to FIG. 2, the user may then touch the portion of the active area 146 corresponding to a “home” list item, thereby selecting “home” as the navigation destination.

It will be understood that the arrangements described herein are illustrative, and any arrangement of touch-elements 142 and interactive elements 122 is within the scope of this disclosure. Moreover, correlations between various arrangements of interactive elements 122 and various arrangements of touch-input surface elements 142 may be stored in the memory 164, and may be referred to by the processor 162 in controlling the relevant components.

It will also be understood that, while the touch-input surface elements 142 are shown as rectangular in shape, the touch-input surface elements 142 may be of any shape or configuration that allows for the adaptation of the surface profile in connection with the display of the interactive elements 122. In particular, it will be understood that configurations in which the touch-input interface 140 takes on a curved profile (e.g., a track ball like), or a more modular profile (e.g., keyboard like) are expressly contemplated.

It will further be understood that the touch-input interface 140 may be configured to recognize and receive various touch input actions in addition to or alternatively to the touch-selection described herein for illustrative purposes. Such touch input actions may include clicking, scrolling, dragging, selecting, zooming, swiping, pointing, and other actions known for providing touch input via touch sensitive surface user interfaces, which actions may include statically or dynamically contacting the active area 146 at one or more locations of the touch-input interface 140.

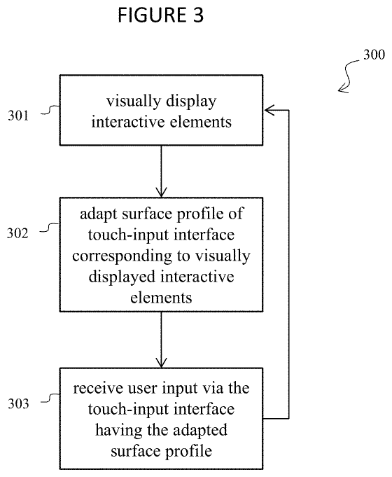

A method for providing user input to a software application via an adaptive touch user interface will now be described with reference to FIG. 3.

At step 301, interactive elements 122 are visually displayed on the visual display 120 in accordance with the software application. As discussed herein, this may involve displaying the interactive elements 122 in various arrangements.

At step 302, the surface profile of the touch-input interface 140 is adapted in connection with the display of the interactive elements 122. As discussed herein, this may involve actuating the touch-elements 142 (e.g., via extending/retracting them) to form the active area 146 corresponding to the arrangement of the interactive elements 122.

At step 303, user input is received by the touch-elements 142 of active area 146, which received user input is communicated to the software application. If the receipt of the user touch input by the software application results in the software application modifying the arrangement of interactive elements 122, then the process returns to Step 301.

The objects, advantages and features described in detail above are considered novel over the prior art of record and are considered critical to the operation of at least one embodiment of the present invention and to the achievement of at least one objective of the present invention. The words used in this specification to describe these objects, advantages and features are to be understood not only in the sense of their commonly defined meanings, but also to include any special definition with regard to structure, material or acts that would be understood by one of ordinary skilled in the art to apply in the context of the entire disclosure.

Moreover, various elements described herein generally include hardware and/or software/firmware, including but not limited to: processors, memories, input/output interfaces, operating systems and network interfaces, configured to effectuate the functionalities described herein. When implemented in software, the elements of the invention are essentially the code segments to perform the necessary tasks. The code segments can be stored in a processor readable medium or transmitted by a computer data signal. The “processor readable medium” may include any medium that can store information. Examples of the processor readable medium include an electronic circuit, a semiconductor memory device, a ROM, a flash memory or other non-volatile memory, a floppy diskette, a CD-ROM, an optical disk, a hard disk, etc.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

Moreover, the definitions of the words or drawing elements described herein are meant to include not only the combination of elements which are literally set forth, but all equivalent structures, materials or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements in a claim without departing from the scope of the present invention.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted in conjunction with the appended claims.

What is claimed is:

1. A system for an adaptive touch user interface, comprising:
a visual display configured to display one or more interactive elements thereon in accordance with a software application that receives user input in connection with displayed information; and
a touch-input interface having a surface profile adaptable in connection with the display of the one or more interactive elements, the touch-input interface configured to receive user input and communicate the user input to the software application.

2. The system of claim 1, further including one or more actuators configured to adapt the surface profile of the touch-input interface in connection with the display of the one or more interactive elements.

3. The system of claim 1, wherein the touch-input interface comprises a plurality of touch-input surface elements that define the surface profile, each touch-input surface element being individually extendable and retractable to adjust the surface profile in connection with the display of the one or more interactive elements.

4. The system of claim 3, wherein extended touch-input surface elements are activated so as to receive the user input; and wherein retracted touch-input surface elements are deactivated so as to not receive the user input.

5. The system of claim 3, wherein the plurality of touch-input surface elements comprise an array of substantially rectangular touch-input surface elements.

6. The system of claim 3, wherein the plurality of touch-input surface elements comprise a matrix of substantially square touch-input surface elements

7. The system of claim 1, wherein the touch-input interface is configured to adapt to form one or more of: a substantially planar surface profile, a bar surface profile, a track ball surface profile, and a keyboard surface profile.

8. The system of claim 1, wherein the user input communicates interaction with the interactive elements by way of the touch-input interface via one or more of: clicking, scrolling, dragging, selecting, zooming, swiping, and pointing actions on the touch-input interface.

9. The system of claim 1, wherein the touch-input interface is substantially flush with a vehicle panel, when adjusted to a neutral surface profile.

10. A vehicle having an adaptive touch user interface, the vehicle comprising:
a control unit configured to execute a software application for controlling one or more vehicle systems, the software application receiving user input in connection with displayed information;
a visual display configured to display one or more interactive elements thereon in accordance with the software application; and
a touch-input interface having a surface profile adaptable in connection with the display of the one or more interactive elements, the touch-input interface configured to receive user input and communicate the user input to the software application.

11. The vehicle of claim 10, further including one or more actuators configured to adapt the surface profile of the touch-input interface in connection with the display of the one or more interactive elements.

12. The vehicle of claim 10, wherein the touch-input interface comprises a plurality of touch-input surface elements that define the surface profile, each touch-input surface element being individually extendable and retractable to adjust the surface profile in connection with the display of the one or more interactive elements.

13. The vehicle of claim 12, wherein extended touch-input surface elements are activated so as to receive the user input; and wherein retracted touch-input surface elements are deactivated so as to not receive the user input.

14. The vehicle of claim 12, wherein the plurality of touch-input surface elements comprise an array of substantially rectangular touch-input surface elements.

15. The vehicle of claim 12, wherein the plurality of touch-input surface elements comprise a matrix of substantially square touch-input surface elements

16. The vehicle of claim 10, wherein the touch-input interface is configured to adapt to form one or more of: a substantially planar surface profile, a bar surface profile, a track ball surface profile, and a keyboard surface profile.

17. The vehicle of claim 10, wherein the user input communicates interaction with the interactive elements by way of the touch-input interface via one or more of: clicking, scrolling, dragging, selecting, zooming, swiping, and pointing actions on the touch-input interface.

18. The vehicle of claim 10, wherein the touch-input interface is substantially flush with a panel of the vehicle, when adjusted to a neutral surface profile.

19. A method for providing user input to a software application, the method comprising:
visually displaying interactive elements on a visual display in accordance with the software application;
adapting a surface profile of a touch-input interface in connection with the display of the one or more interactive elements;
receiving user input via the touch-input interface having the adapted surface profile;
communicating the received user input to the software application.
